(19) United States
(12) Patent Application Publication
(10) Pub. No.: US 2019/0097284 A1
(43) Pub. Date: Mar. 28, 2019

(54) POWER STORAGE DEVICE PACK

(71) Applicant: KABUSHIKI KAISHA TOYOTA JIDOSHOKKI, Aichi (JP)

(72) Inventors: Fumihiko ISHIGURO, Aichi (JP); Takayuki KATO, Aichi (JP); Hiromi UEDA, Aichi (JP); Kazuki MAEDA, Aichi (JP)

(73) Assignee: KABUSHIKI KAISHA TOYOTA JIDOSHOKKI, Aichi (JP)

(21) Appl. No.: 16/082,700

(22) PCT Filed: Dec. 6, 2016
(86) PCT No.: PCT/JP2016/086229

§ 371 Date: Sep. 6, 2018

(30) Foreign Application Priority Data
Mar. 15, 2016 (JP) 2016-051162

(51) Int. Cl. H01M 10/6555; H01M 10/647; H01M 10/613; H01M 2/10

(52) U.S. Cl. CPC H01M 10/6555; H01M 2/1016; H01M 10/613; H01M 10/647

(57) ABSTRACT

A power storage device pack includes a housing and a power storage device module fixed to the housing. The power storage device module includes a plurality of power storage devices arranged in one direction, a pair of binding members configured to bind the power storage devices at both ends in the one direction, an elastic member arranged between one of the binding members and one of the power storage devices and configured to absorb expansion of the power storage devices, and a plurality of heat-transfer plates arranged so as to respectively make contact with the power storage devices. A plurality of heat-conduction members are configured to respectively conduct heat from the heat-transfer plates to the housing, and a plurality of sliding members respectively joined to first ends of the heat-conduction members and relatively slidable in the one direction, are arranged between the heat-transfer plates and the housing.

### TECHNICAL FIELD

An aspect of the present invention relates to a power storage device pack.

### BACKGROUND ART

As a power storage device pack, a battery pack described in Patent Literature 1 is known, for example. The battery pack described in Patent Literature 1 includes a plurality of stacked type battery cells, a plurality of positioning plates stacked on the respective stacked type battery cells, a biasing part biasing the plurality of stacked type battery cells and the plurality of the positioning plates in the stacked direction, and a housing that houses the plurality of stacked type battery cells, the plurality of the positioning plates, and the biasing part. Bent parts (heat-dissipation parts) of the positioning plates are pressed against the housing while interposing respective heat-conduction sheets.

### CITATION LIST

### Patent Literature

Patent Literature 1: Japanese Unexamined Patent Publication No. 2014-175078

### SUMMARY OF INVENTION

### Technical Problem

However, the above-described conventional technology has a problem as follows. That is, owing to degradation or charge and discharge of the stacked type battery cells, the stacked type battery cells expand toward the biasing part. Meanwhile, the heat-conduction sheets are joined to the respective heat-dissipation parts of the positioning plates and the housing. Accordingly, when the stacked type battery cells expand, the positioning plates move together, whereby a load in a shear direction is applied to the heat-conduction sheets. Owing to this, boundary separations between the positioning plates and the heat-conduction sheets or boundary separations between the heat-conduction sheets and the housing occur, or ruptures of the heat-conduction sheets occur. As a result, it becomes hard to transfer heat from the heat-dissipation parts of the positioning plates to the housing, thereby decreasing heat dissipation to the housing.

An aspect of the present invention is to provide a power storage device pack capable of improving heat dissipation to a housing.

### Solution to Problem

A power storage device pack according to an aspect of the present invention comprises a housing and a power storage device module fixed to the housing, the power storage device module including a plurality of power storage devices arranged in one direction, a pair of binding members configured to bind the plurality of power storage devices at both ends in the one direction, an elastic member arranged between one of the binding members and one of the power storage devices and configured to absorb expansion of the power storage devices, and a plurality of heat-transfer plates arranged in such a way as to respectively make contact with the plurality of power storage devices. A plurality of heat-conduction members configured to respectively conduct heat from the plurality of heat-transfer plates to the housing, and a plurality of sliding members respectively joined to first ends of the plurality of heat-conduction members and relatively slidable in the one direction are arranged between the plurality of heat-transfer plates and the housing.

In such a power storage device pack, heat generated in the power storage devices is dissipated through the heat-transfer plates and the heat-conduction members to the housing. Here, the sliding members relatively slidable in the one direction (the direction in which the power storage devices are arranged) are arranged between the heat-transfer plates and the housing. Accordingly, when the power storage devices expand owing to degradation or charge and discharge of the power storage devices, the sliding members relatively slide in the one direction, whereby a load in a shear direction is prevented from being applied to the heat-conduction members joined to the sliding members. Owing to this, boundary separations between the heat-transfer plates and the heat-conduction members or boundary separations between the heat-conduction members and the housing, and ruptures of the heat-conduction members are prevented. This makes it possible to improve heat dissipation to the housing.

The sliding members may be arranged between the heat-conduction members and the housing and may be slidable in the one direction relative to the housing. In this case, when the power storage devices expand, the sliding members slide in the one direction relative to the housing. Consequently, relative positions of the heat-transfer plates and the heat-conduction members become always constant, thereby stabilizing the heat dissipation to the housing.

Each of the heat-transfer plates may include a main body part making contact with a main surface of a corresponding one of the power storage devices and a heat-transfer part bent in the one direction at one end of the main body part. Other ends of the heat-conduction members may be joined to the respective heat-transfer parts, and the other ends of the heat-conduction members may be joined to the heat-transfer parts in such a way as to be offset toward the respective main body parts of the heat-transfer parts. Heat generated in the power storage devices is transferred from the main body parts to the heat-transfer parts in the heat-transfer plates. Thermal conductivities of main body part sides of the heat-transfer parts therefore are superior to thermal conductivities of sides opposite to the main body parts in the heat-transfer parts. Accordingly, it is possible to further improve the heat dissipation to the housing by joining the other ends of the heat-conduction members to the heat-transfer parts in such a way as to be offset toward the main body parts.

The sliding members may be arranged between the heat-transfer plates and the heat-conduction members and may be slidable in the one direction relative to the heat-transfer plates. In this case, in producing the power storage device pack, the first end of each of the heat-conduction members is joined to a corresponding one of the sliding members, and the other end of each of the heat-conduction members is joined to the housing. As a result, in fixing the power storage device module to the housing thereafter, the heat-conduction members and the sliding members hardly fall off.

Each of the heat-transfer plates may include the main body part making contact with the main surface of the corresponding one of the power storage devices and the heat-transfer part bent toward the elastic member in the one direction at the one end of the main body part. The sliding members may be in contact with the respective heat-transfer parts, and the other ends of the heat-conduction members may be joined to the housing. The heat generated in the power storage devices is transferred from the main body parts to the heat-transfer parts in the heat-transfer plates. The thermal conductivities of the main body part sides of the heat-transfer parts therefore are superior to the thermal conductivities of the sides opposite to the main body parts in the heat-transfer parts. Accordingly, by bending the heat-transfer parts toward the elastic member in the one direction at the first ends of the main body parts in the heat-transfer plates, when the power storage devices expand, the sliding members slide toward the main body parts relative to the heat-transfer parts of the heat-transfer plates from the sides opposite to the main body parts (elastic member sides); thus, the heat-conduction members move from the elastic member sides to the main body part sides. Consequently, it is possible to further improve the heat dissipation to the housing.

A power storage device pack according to another aspect of the present invention comprises a housing and a power storage device module fixed to the housing, the power storage device module including a plurality of power storage devices arranged in one direction, a pair of binding members configured to bind the plurality of power storage devices at both ends in the one direction, an elastic member arranged between one of the binding members and one of the power storage devices and configured to absorb expansion of the power storage devices, and a plurality of heat-transfer surfaces configured to thermally connect the plurality of power storage devices and the housing, respectively. A plurality of heat-conduction members configured to respectively conduct heat from the plurality of heat-transfer surfaces to the housing, and a plurality of sliding members respectively joined to first ends of the plurality of heat-conduction members and relatively slidable in the one direction are arranged between the plurality of heat-transfer surfaces and the housing.

In such a power storage device pack, heat generated in the power storage devices is dissipated through the heat-conduction members from the heat-transfer surfaces to the housing. Here, the sliding members relatively slidable in the one direction are arranged between the heat-transfer surfaces and the housing. Accordingly, when the power storage devices expand owing to degradation or charge and discharge of the power storage devices, the sliding members relatively slide in the one direction, whereby a load in a shear direction is prevented from being applied to the heat-conduction members joined to the sliding members. Owing to this, boundary separations between the heat-transfer surfaces and the heat-conduction members or boundary separations between the heat-conduction members and the housing, and ruptures of the heat-conduction members are prevented. This makes it possible to improve heat dissipation to the housing.

The sliding members may be arranged between the heat-conduction members and the housing and may be slidable in the one direction relative to the housing. In this case, when the power storage devices expand, the sliding members slide in the one direction relative to the housing. Consequently, relative positions of the heat-transfer surfaces and the heat-conduction members become always constant, thereby stabilizing the heat dissipation to the housing.

The sliding members may be arranged between the heat-transfer surfaces and the heat-conduction members and may be slidable in the one direction relative to the heat-transfer surfaces. In this case, in producing the power storage device pack, the first end of each of the heat-conduction members is joined to a corresponding one of the sliding members, and another end of each of the heat-conduction members is joined to the housing. As a result, in fixing the power storage device module to the housing thereafter, the heat-conduction members and the sliding members hardly fall off.

The power storage device module may further include a plurality of heat-transfer plates arranged in such a way as to make contact with the respective power storage devices. Each of the heat-transfer plates may include a main body part making contact with a main surface of a corresponding one of the power storage devices and a heat-transfer part bent in the one direction at one end of the main body part. The heat-transfer part may include the heat-transfer surface. In this case, heat generated in the power storage devices is transferred to the heat-transfer plates and is dissipated to the housing through the heat-conduction members and the sliding members.

A width of each of the sliding members may be greater than or equal to a width of the corresponding heat-conduction member. In this case, in fixing the power storage device module to the housing, the heat-conduction members are prevented from being adhered to the housing, the heat-transfer plates, or the heat-transfer surfaces due to collapse of the heat-conduction members. Thus, the sliding members are relatively and smoothly slidable in the one direction.

### Advantageous Effects of Invention

According to an aspect of the present invention, a power storage device pack capable of improving heat dissipation to a housing is provided.

### BRIEF DESCRIPTION OF DRAWINGS

FIG. 1 is a perspective view illustrating a battery pack as a power storage device pack according to an embodiment of the present invention.

FIG. 2 is a perspective view illustrating an appearance of the battery module shown in FIG. 1.

FIG. 3 is an exploded perspective view illustrating a battery unit shown in FIG. 2.

FIG. 4 shows cross-sectional views schematically illustrating that the battery module is fixed to a housing in the battery pack as the power storage device pack according to a first embodiment of the present invention.

FIG. 5 is a cross-sectional view schematically illustrating that the battery module is fixed to the housing in a battery pack as a comparative example.

FIG. 6 shows cross-sectional views schematically illustrating that the battery module is fixed to the housing in a battery pack as a power storage device pack according to a second embodiment of the present invention.

### DESCRIPTION OF EMBODIMENTS

Hereinafter, embodiments of the present invention will be described in detail with reference to the drawings. Note that, in the drawings, identical or equivalent components have the same reference numerals and the redundant description will be omitted.

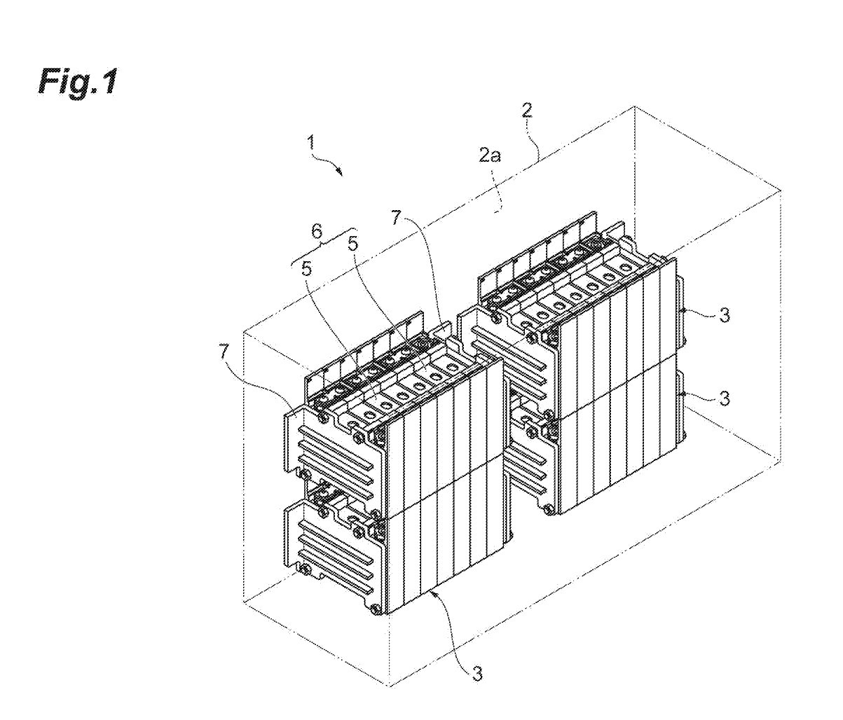

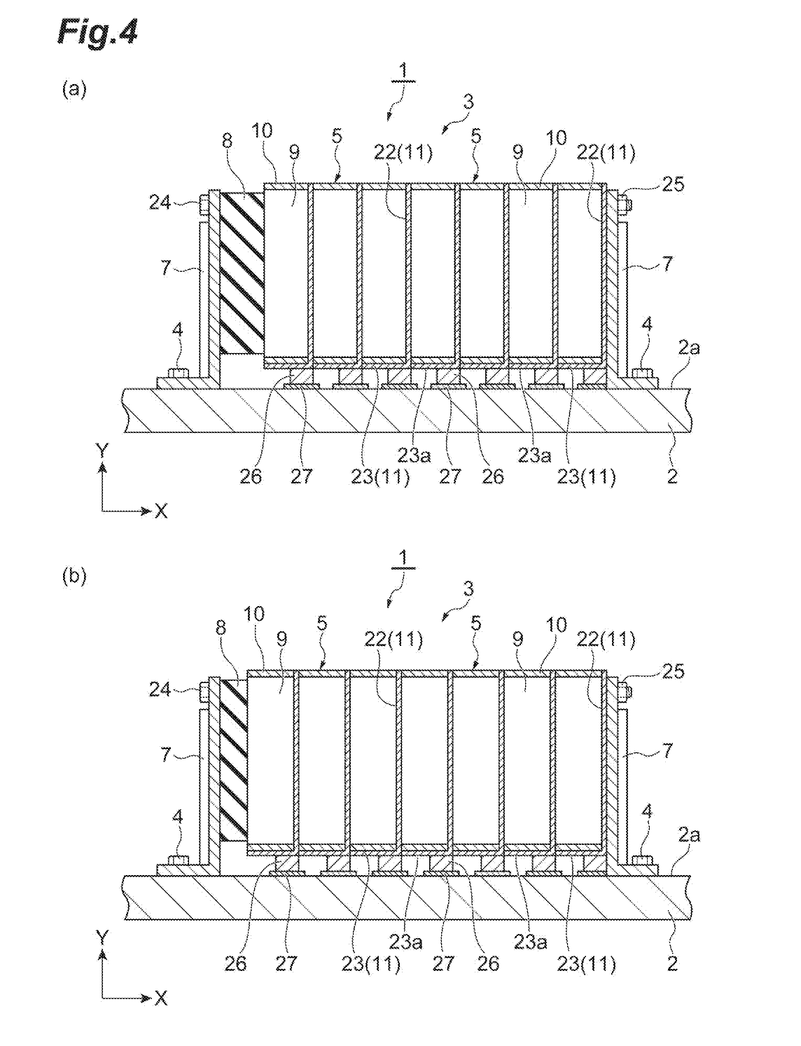

FIG. 1 is a perspective view illustrating a battery pack as a power storage device pack according to an embodiment of the present invention. In FIG. 1, a battery pack 1 (the power storage device pack) of the embodiment comprises a rectangular box-shaped housing 2 and a plurality of (four in this embodiment) battery modules 3 (power storage device modules) stored within the housing 2. Each of the battery modules 3 is fixed to an inner wall surface 2a of the housing 2 with a plurality of bolts 4 (see FIG. 4). The housing 2 is formed of metal (e.g., iron).

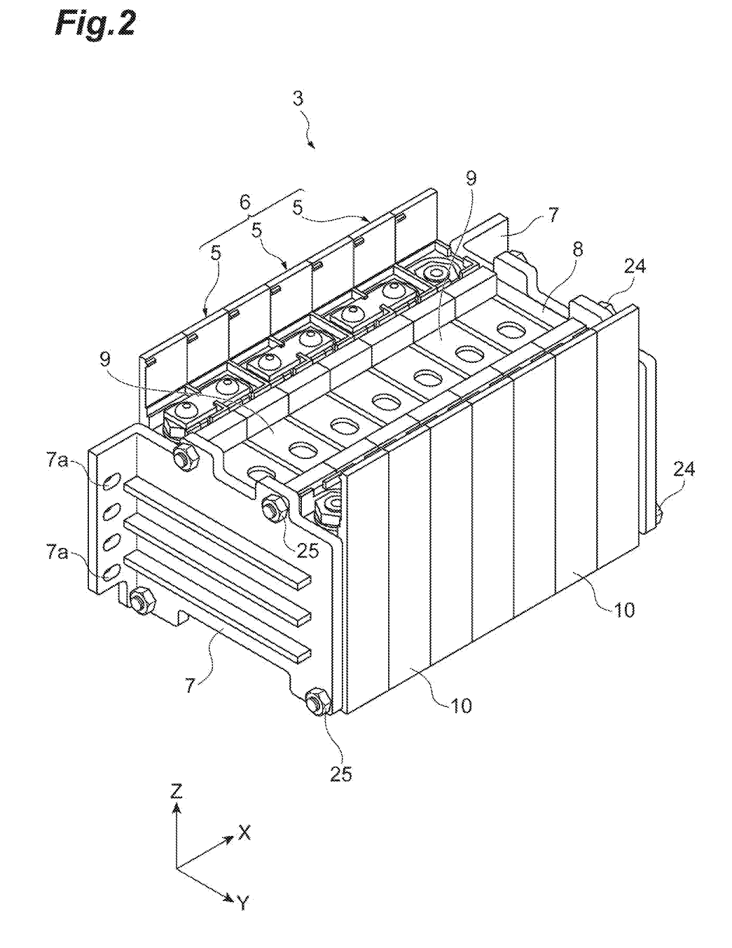

FIG. 2 is a perspective view illustrating an appearance of the battery module 3. In FIG. 2, the battery module 3 includes a battery unit group 6 consisting of a plurality of (seven in this embodiment) battery units 5 arranged in one direction (an X axis direction), a pair of end plates 7 arranged at both ends of the battery unit group 6, and an elastic member 8 arranged between one of the end plates 7 and one of the battery units 5 that is positioned at one end of the battery unit group 6.

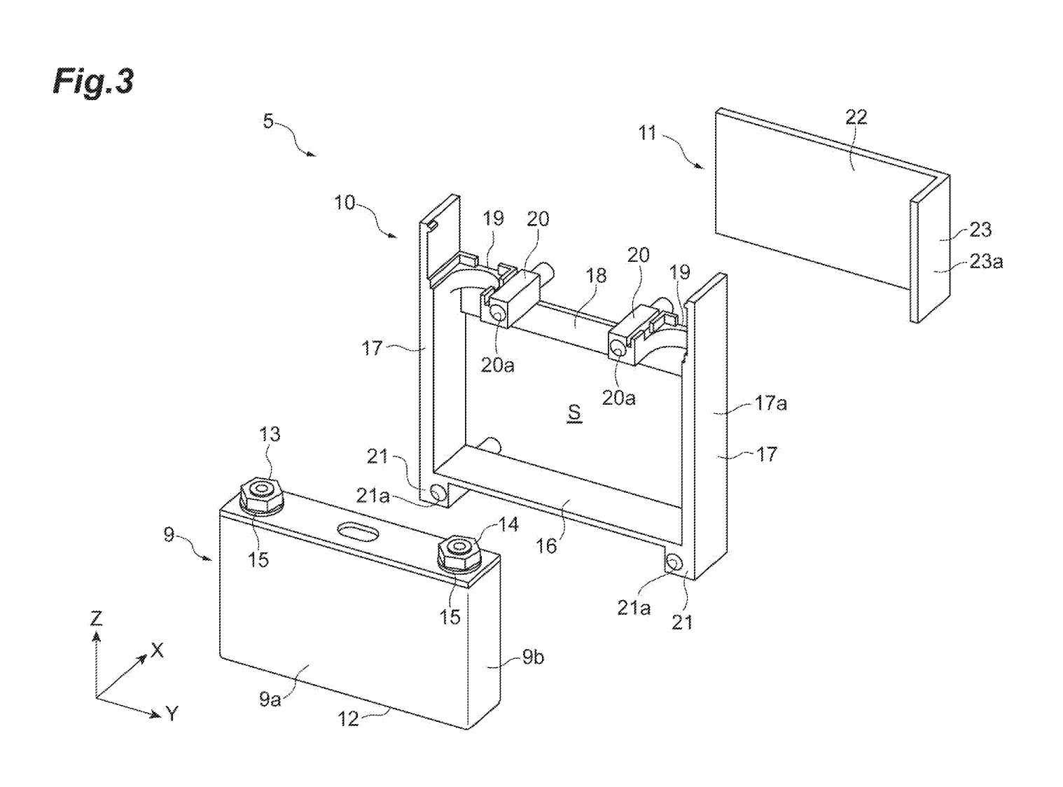

As shown in FIG. 3, each of the battery units 5 has a secondary battery 9 being a power storage device, a cell holder 10 holding the secondary battery, and an L-shaped heat-transfer plate 11 arranged in such a way as to make contact with the secondary battery 9.

The secondary battery 9 is a lithium ion secondary battery formed such that an electrode assembly (not shown) is stored in a rectangular parallelepiped case 12, for example. The electrode assembly has a structure in which a plurality of positive electrode sheets and a plurality of negative electrode sheets are alternately stacked via separators. A positive electrode terminal 13 and a negative electrode terminal 14 are attached on top of the case 12 via respective insulating rings 15. The positive electrode terminal 13 is electrically connected to the positive electrode sheets. The negative electrode terminal 14 is electrically connected to the negative electrode sheets. Note that, an electrolyte (not shown) is filled in the case 12. The secondary battery 9 has a pair of main surfaces 9a and a pair of side surfaces 9b. The main surfaces 9a are surfaces that are perpendicular to the X axis direction in the secondary battery 9. The side surfaces 9b are surfaces that are perpendicular to a Y axis direction in the secondary battery 9.

The cell holder 10 is a frame-shaped member that is integrally formed using resin. The cell holder 10 has a bottom wall part 16 on which the secondary battery 9 is mounted, a pair of side wall parts 17 erected at both ends of the bottom wall part 16 and sandwiching the secondary battery 9 in a width direction (the Y axis direction), and a connection part 18 connecting each of the side wall parts 17 together. A space surrounded by the bottom wall part 16, side wall parts 17, and the connection part 18 defines an accommodation space S where the secondary battery 9 is accommodated.

A terminal receiving part 19 that partially surrounds a corresponding one of the positive electrode terminal 13 and the negative electrode terminal 14 of the secondary battery 9 is provided on top of both ends in the connection part 18. Bolt guide parts 20 each having a through-hole 20a through which a shaft of a bolt 24 (see FIG. 2) described below passes are provided on the top of the connection part 18, at inner side in the width direction with respect to the terminal receiving parts 19. Bolt guide parts 21 each having a through-hole 21a through which a shaft of a bolt 24 passes are provided on respective lower parts on both ends of the bottom wall part 16.

As shown in FIGS. 3 and 4, each of the heat-transfer plates 11 has a main body part 22 making contact with the main surface 9a of the secondary battery 9 and a heat-transfer part 23 bent at an end in a longitudinal direction of the main body part 22 toward the elastic member 8 in the direction (the X axis direction) in which the secondary batteries 9 are arranged. The heat-transfer part 23 covers an outer surface 17a (a surface opposite to the accommodation space S) of one of the side wall parts 17 of the cell holder 10. The heat-transfer part 23 has a heat-transfer surface 23a. The heat-transfer surface 23a is a surface that faces the inner wall surface 2a when the battery module 3 is fixed to the inner wall surface 2a of the housing 2.

Referring back to FIG. 2, the end plates 7 are L-shaped binding members that bind the secondary batteries 9 at both ends in the arrangement direction of the secondary batteries 9 in cooperation with a plurality of pairs of (four pairs in this embodiment) the bolts 24 and nuts 25. The end plates 7 are formed of metal having high rigidity (e.g., iron). A plurality of insertion holes 7a through which respective shafts of the bolts 4 (see FIG. 4) for fixing the battery module 3 to the housing 2 pass are provided in each of the end plates 7. Two pairs of the bolts 24 and the nuts 25 are arranged on each of upper and lower parts in a vertical direction (a Z axis direction) of the battery module 3. The elastic member 8 is arranged between one of the end plates 7 and one of the secondary batteries 9 and is a flat plate rubber that absorbs expansion of the secondary batteries 9.

FIG. 4 shows cross-sectional views schematically illustrating that the battery module 3 is fixed to the housing 2 in the battery pack 1 as the power storage device pack according to a first embodiment of the present invention. Note that, (a) in FIG. 4 illustrates the secondary batteries 9 before expansion, whereas (b) in FIG. 4 illustrates the secondary batteries 9 being expanded.

In FIG. 4, a plurality of heat-conduction members 26 and a plurality of slip sheets 27 are arranged between the respective heat-transfer plates 11 (heat-transfer surfaces 23a) of the battery units 5 and the housing 2. Each of the heat-conduction members 26 and each of the slip sheets 27 are arranged for each of the heat-transfer plates 11. Each of the slip sheets 27 is arranged between the corresponding heat-conduction member 26 and the housing 2.

The heat-conduction members 26 are members that conduct heat from the heat-transfer plates 11 to the housing 2 and are referred to as TIMs (Thermal Interface Materials). The heat-conduction members 26 are formed of a material having stickiness. Examples of the material having stickiness include silicon, acrylic, and urethane. The heat-conduction members 26 are arranged on the respective heat-transfer surfaces 23a.

One ends of the heat-conduction members 26 are joined to the respective slip sheets 27 and other ends of the heat-conduction members 26 are joined to the respective heat-transfer surfaces 23a of the heat-transfer parts 23 in the heat-transfer plates 11. Specifically, each of the other ends of the heat-conduction members 26 is joined to the heat-transfer surface 23a in such a way as to be offset toward a base end (the main body part 22) of the heat-transfer part 23 with respect to a center in the X axis direction of the heat-transfer part 23.

The slip sheets 27 are sliding members slidable in the arrangement direction of the secondary batteries 9 relative to the housing 2. The slip sheets 27 are formed of a resin material having heat conductivity and a low coefficient of friction, such as polyethylene terephthalate (PET). Note that, a thermally conductive filler may be contained in slip sheets. Widths (lengths in the X axis direction) of the slip sheets 27 are greater than or equal to widths (lengths in the X axis direction) of the heat-conduction members 26. In FIG. 4, the widths of the slip sheets 27 are greater than the widths of the heat-conduction members 26.

In producing such a battery pack 1 described above, first, the battery module 3 is assembled. Thereafter, the one ends of the heat-conduction members 26 are joined to the respective slip sheets 27 and the other ends of the heat-conduction members 26 are joined to the respective heat-transfer parts 23 (heat-transfer surfaces 23a) of the heat-transfer plates 11 in the battery module 3. At this time, an initial length (a length in the Y axis direction) of each of the heat-conduction members 26 is made long enough to allow for a positional displacement in a width direction (the Y axis direction) of each of the battery units 5. In addition, an initial width (length in the X axis direction) of each of the heat-conduction members 26 is made small so that the heat-conduction members 26 do not protrude from the slip sheets 27 even when the heat-conduction members 26 collapse.

Subsequently, the battery module 3 is arranged on a predetermined mounting position such that each of the slip sheets 27 comes in contact with the inner wall surface 2a of the housing 2, and in that state, the battery module 3 is fixed to the housing 2 with the bolts 4. With this, the heat-conduction members 26 collapse, and whereby the heat-conduction members 26 are brought into sufficiently close contact with the respective heat-transfer plates 11 and the respective slip sheets 27. In addition, when the heat-conduction members 26 collapse, the widths of the heat-conduction members 26 increase; however, the heat-conduction members 26 do not protrude from the slip sheets 27.

In such a battery pack 1, when the secondary batteries 9 degrade, heat is likely to be generated from the secondary batteries 9. The heat generated in the secondary batteries 9 is dissipated through heat-transfer plates 11, the heat-conduction members 26 and the slip sheets 27 to the housing 2. On the other hand, as shown in (b) in FIG. 4, the secondary batteries 9 expand toward the elastic member 8 in degradation or charge and discharge of the secondary batteries 9. At this time, though the heat-conduction members 26 are in close contact with the heat-transfer plates 11 and the slip sheets 27, the slip sheets 27 and the housing 2 are slidable relative to each other. Accordingly, the battery units 5, the heat-conduction members 26, and the slip sheets 27 move in unison with each other toward the elastic member 8 relative to the housing 2.

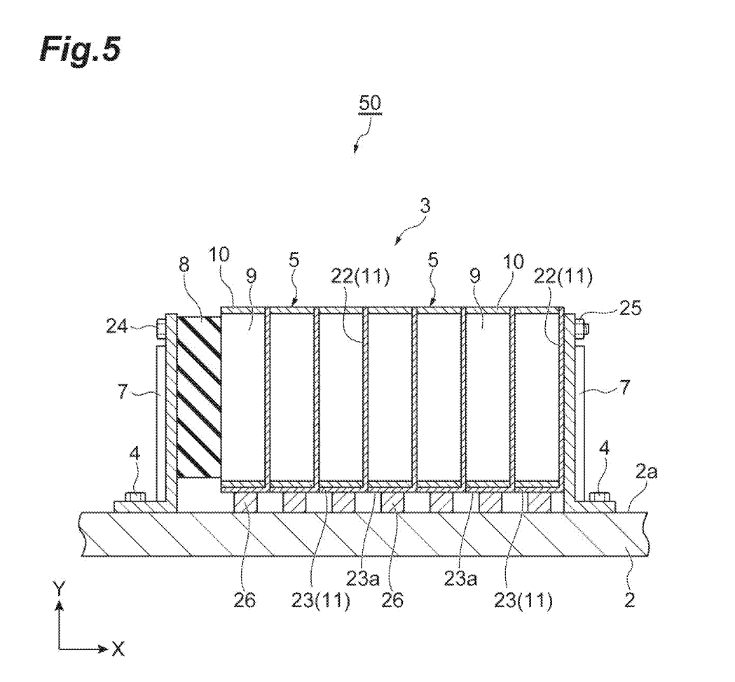

FIG. 5 is a cross-sectional view schematically illustrating that the battery module 3 is fixed to the housing 2 in a battery pack as a comparative example. In FIG. 5, a battery pack 50 as a comparative example does not include the slip sheets 27. In other words, the heat-conduction members 26 are joined to the housing 2 (inner wall surface 2a). In such a configuration, following problems occur.

That is, the secondary batteries 9 expand toward the elastic member 8 owing to the degradation or charge and discharge of the secondary batteries 9, whereby a load in a shear direction is applied to the heat-conduction members 26. Thus, boundary separations between the heat-transfer plates 11 and the heat-conduction members 26 or boundary separations between the heat-conduction members 26 and the housing 2 are likely to occur, or ruptures of the heat-conduction members 26 are likely to occur. As a result, it becomes hard to transfer heat from the heat-transfer plates 11 to the housing 2, thereby decreasing the heat dissipation to the housing 2.

Meanwhile, in a case where one slip sheet extending in a direction in which the battery units 5 are arranged is used, the slip sheet is slightly offset relative to the housing 2 when the secondary batteries 9 expand toward the elastic member 8; however, a pitch of each of the heat-conduction members 26 in a boundary between each of the heat-conduction members 26 and the slip sheet remains the same as before the expansion of the secondary batteries 9. Consequently, in this case as well, a load in the shear direction is applied to the heat-conduction members 26, thereby decreasing the heat dissipation to the housing 2 as with the comparative example.

On the other hand, according to the embodiment, the slip sheets 27 relatively slidable in the arrangement direction of the secondary batteries 9 are provided between the heat-transfer plates 11 (heat-transfer surfaces 23a) and the housing 2. The slip sheets 27 are joined to the respective one ends of the heat-conduction members 26. Accordingly, when the secondary batteries 9 expand owing to the degradation or charge and discharge of the secondary batteries 9, the slip sheets 27 relatively slide in the arrangement direction of the secondary batteries 9, whereby the load in the shear direction is prevented from being applied to the heat-conduction members 26 joined to the slip sheets 27. Owing to this, the boundary separations between the heat-transfer plates 11 and the heat-conduction members 26 or the boundary separations between the heat-conduction members 26 and the housing 2, and the ruptures of the heat-conduction members 26 are prevented. This makes it possible to improve the heat dissipation to the housing 2 because the heat is reliably transferred from the heat-transfer plates 11 to the housing 2.

Moreover, in the embodiment, the slip sheets 27 are arranged between the respective heat-conduction members 26 and the housing 2. Accordingly, when the secondary batteries 9 expand, the slip sheets 27 slide in the arrangement direction of the secondary batteries 9 relative to the housing 2. Consequently, relative positions of the heat-transfer plates 11 and the heat-conduction members 26 become always constant, thereby stabilizing the heat dissipation to the housing 2.

Further, the heat generated in the secondary batteries 9 is transferred from the main body parts 22 to the heat-transfer parts 23 in the heat-transfer plates 11. Accordingly, a heat dissipation path to the housing 2 becomes shorter in a part closer to the base end than in a distal end in each of the heat-transfer parts 23. Thus, the thermal conductivities of base end sides of the heat-transfer parts 23 (main body part 22 sides of the heat-transfer parts 23) are superior to the thermal conductivities of distal end sides of the heat-transfer parts 23 (sides opposite to the main body parts 22 in the heat-transfer parts 23). According to the embodiment, it is possible to further improve the heat dissipation to the housing 2 because the heat-conduction members 26 are joined to the respective heat-transfer parts 23 in such a way as to be offset toward the base ends of the heat-transfer parts 23.

Furthermore, in the embodiment, in fixing the battery module 3 to the housing 2, the heat-conduction members 26 are prevented from being adhered to the housing 2 due to the collapse of the heat-conduction members 26 because the widths of the slip sheets 27 are greater than or equal to the widths of the heat-conduction members 26. Thus, the slip sheets 27 are smoothly slidable in the arrangement direction of the secondary batteries 9 relative to the housing 2.

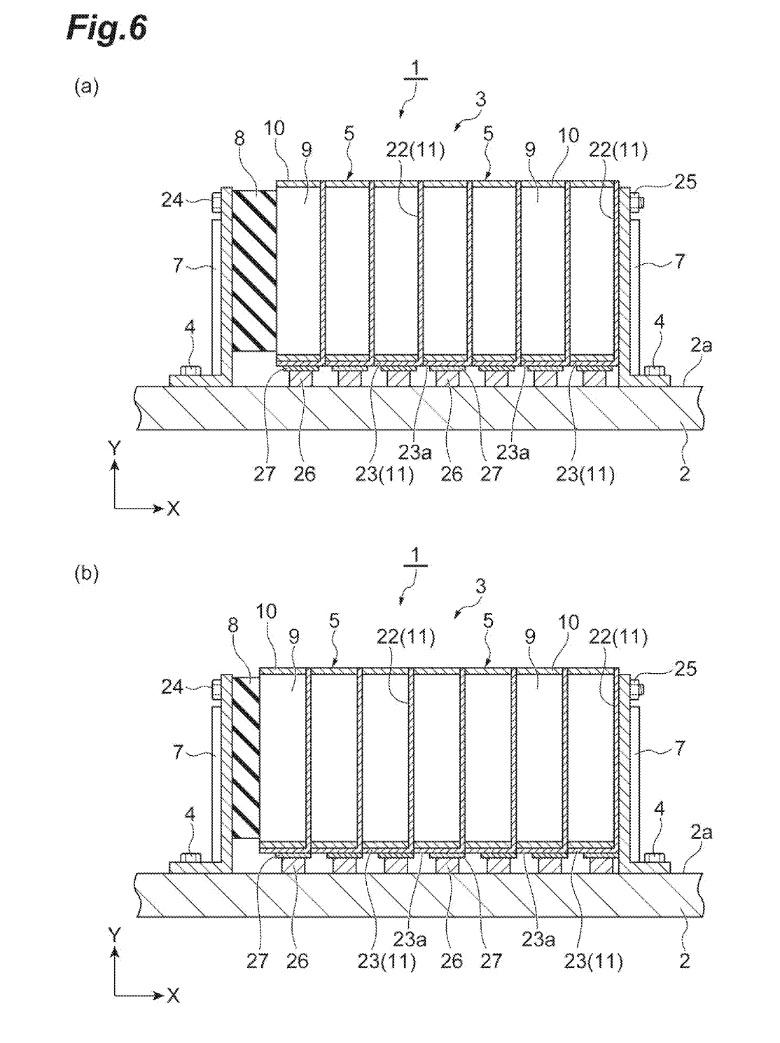

FIG. 6 shows cross-sectional views schematically illustrating that the battery module 3 is fixed to the housing 2 in a battery pack 1 as a power storage device pack according to a second embodiment of the present invention. Note that, (a) in FIG. 6 illustrates the secondary batteries 9 before expansion, whereas (b) in FIG. 6 illustrates the secondary batteries 9 being expanded.

In FIG. 6, as with the first embodiment, the heat-conduction members 26 and the slip sheets 27 are arranged between the heat-transfer plates 11 (heat-transfer surfaces 23a) in the battery module 3 and the housing 2.

Each of the slip sheets 27 is arranged between each of the heat-transfer plates 11 and each of the heat-conduction members 26. The one ends of the heat-conduction members 26 are joined to the respective slip sheets 27 and the other ends of the heat-conduction members 26 are joined to the housing 2. The slip sheets 27 are in contact with the respective heat-transfer parts 23 (heat-transfer surfaces 23a) of the heat-transfer plates 11. The slip sheets 27 are in contact with center parts in the X axis direction of the heat-transfer parts 23. The widths of the slip sheets 27 are greater than or equal to the widths of the heat-conduction members 26.

In producing such a battery pack 1, after the battery module 3 is assembled, the one ends of the heat-conduction members 26 are joined to the respective slip sheets 27 and the other ends of the heat-conduction members 26 are joined to the housing 2 (inner wall surface 2a). Subsequently, the battery module 3 is arranged on a predetermined mounting position such that each of the heat-transfer plates 11 comes in contact with each of the slip sheets 27, and in that state, the battery module 3 is fixed to the housing 2 with the bolts 4. With this, the heat-conduction members 26 collapse, and whereby the heat-conduction members 26 are brought into sufficiently close contact with the respective slip sheets 27 and the housing 2.

In such a battery pack 1, as shown in (b) in FIG. 6, the secondary batteries 9 expand toward the elastic member 8 in degradation or charge and discharge of the secondary batteries 9. At this time, though the heat-conduction members 26 are in close contact with the respective slip sheets 27 and the housing 2, the slip sheets 27 and the heat-transfer plates 11 are slidable relative to each other. Accordingly, the battery units 5 slide toward the elastic member 8 relative to the slip sheets 27. In other words, the slip sheets 27 slide to a side opposite to the elastic member 8 relative to the battery units 5.

According to the embodiment, the slip sheets 27 relatively slidable in the arrangement direction of the secondary batteries 9 are provided between the heat-transfer plates 11 (heat-transfer surfaces 23a) and the housing 2. The slip sheets 27 are joined to the respective one ends of the heat-conduction members 26. Accordingly, when the secondary batteries 9 expand owing to the degradation or charge and discharge of the secondary batteries 9, the slip sheets 27 relatively slide in the arrangement direction of the secondary batteries 9, whereby the load in the shear direction is prevented from being applied to the heat-conduction members 26 joined to the slip sheets 27. Owing to this, the boundary separations between the heat-transfer plates 11 and the heat-conduction members 26 or the boundary separations between the heat-conduction members 26 and the housing 2, and the ruptures of the heat-conduction members 26 are prevented. This makes it possible to improve the heat dissipation to the housing 2 because the heat is reliably transferred from the heat-transfer plates 11 to the housing 2.

In addition, in the embodiment, the slip sheets 27 are arranged between the respective heat-transfer plates 11 (heat-transfer surfaces 23a) and the respective heat-conduction members 26. In such a configuration, in producing the battery pack 1, each of the one ends of the heat-conduction members 26 is joined to a corresponding one of the slip sheets 27, and each of the other ends of the heat-conduction members 26 is joined to the housing 2. As a result, in fixing the battery module 3 to the housing 2 thereafter, the heat-conduction members 26 and the slip sheets 27 hardly fall off.

As described above, the thermal conductivities of the base end sides of the heat-transfer parts 23 (the main body part 22 sides of the heat-transfer parts 23) are superior to the thermal conductivities of the distal end sides of the heat-transfer parts 23 (the sides opposite to the main body parts 22 in the heat-transfer parts 23). In the embodiment, the heat-transfer parts 23 bend at one end of the main body part 22 toward the elastic member 8 in the arrangement direction of the secondary batteries 9, in the heat-transfer plates 11. Accordingly, when the secondary batteries 9 expand, the slip sheets 27 slide relative to the heat-transfer parts 23 of the heat-transfer plates 11 from the distal end sides to the base end sides of the heat-transfer parts 23, whereby the heat-conduction members 26 move from the distal end sides to the base end sides of the heat-transfer parts 23. As a result, it is possible to further improve the heat dissipation to the housing 2.

In addition, in the embodiment, in fixing the battery module 3 to the housing 2, the heat-conduction members 26 are prevented from being adhered to the heat-transfer plates 11 due to the collapse of the heat-conduction members 26 because the widths of the slip sheets 27 are greater than or equal to the widths of the heat-conduction members 26. Thus, the slip sheets 27 are smoothly slidable in the arrangement direction of the secondary batteries 9 relative to the heat-transfer plates 11.

Note that, the present invention is not limited to the aforementioned embodiments. For example, in the first embodiment, the other ends of the heat-conduction members 26 are joined to the heat-transfer parts 23 of the heat-transfer plates 11 in such a way as to be offset toward the base ends of the heat-transfer parts 23, but the form thereof is not particularly limited. The other ends of the heat-conduction members 26 may be joined to the center parts in the X axis direction of the heat-transfer parts 23, for example.

Further, in the second embodiment, the slip sheets 27 are in contact with the center parts in the X axis direction of the heat-transfer parts 23 of the heat-transfer plates 11, but the form thereof is not particularly limited. The slip sheets 27 may be in contact with the heat-transfer parts 23 in such a way as to be offset toward the distal ends of the heat-transfer parts 23, for example.

Moreover, in the embodiments, the heat-transfer parts 23 bend at the one ends of the main body parts 22 toward the elastic member 8 in the arrangement direction of the secondary batteries 9, in the heat-transfer plates 11, but the form thereof is not particularly limited. The heat-transfer parts 23 may bend at the one ends of the main body parts 22 toward the side opposite to the elastic member 8 in the arrangement direction of the secondary batteries 9.

In addition, the battery module 3 only has to include a plurality of heat-transfer surfaces for thermally connecting each of the secondary batteries 9 to the inner wall surface 2a of the housing 2. For example, the battery units 5 may not include the heat-transfer plates 11, and the heat-conduction members 26 and the slip sheets 27 may be provided between the respective outer surfaces 17a of the side wall parts 17 of the cell holders 10 and the inner wall surface 2a of the housing 2. For example, in the first embodiment, the other ends of the heat-conduction members 26 may be joined to the respective outer surfaces 17a of the side wall parts 17 of the cell holders 10. In the second embodiment, the slip sheets 27 may be provided to the respective outer surfaces 17a of the side wall parts 17 of the cell holders 10. In these cases, the outer surfaces 17a of the side wall parts 17 of the cell holders 10 function as the heat-transfer surfaces.

Also, the heat-conduction members 26 and the slip sheets 27 may be provided between the respective side surfaces 9b of the secondary batteries 9 and the inner wall surface 2a of the housing 2. For example, in the first embodiment, the other ends of the heat-conduction members 26 may be joined to the respective side surfaces 9b of the secondary batteries 9. In the second embodiment, the slip sheets 27 may be directly provided on the respective side surfaces 9b of the secondary batteries 9. In these cases, the side surfaces 9b of the secondary batteries 9 function as the heat-transfer surfaces.

Further, in the aforementioned embodiments, the battery pack 1 includes the battery module 3 having the secondary batteries 9 being the lithium ion secondary batteries and the like; however, the present invention is not particularly limited to a secondary battery and is applicable also to a power storage device pack including a power storage device module that has a power storage device such as an electric double-layer capacitor or a lithium ion capacitor.

### REFERENCE SIGNS LIST

1 . . . battery pack (power storage device pack), 2 . . . housing, 3 . . . battery module (power storage device module), 7 . . . end plate (binding member), 8 . . . elastic member, 9 . . . secondary battery (power storage device), 9a . . . main surface, 11 . . . heat-transfer plate, 22 . . . main body part, 23 . . . heat-transfer part, 26 . . . heat-conduction member, 27 . . . slip sheet (sliding member).

1. A power storage device pack comprising:
a housing; and
a power storage device module fixed to the housing,
the power storage device module including a plurality of power storage devices arranged in one direction, a pair of binding members configured to bind the plurality of power storage devices at both ends in the one direction, an elastic member arranged between one of the binding members and one of the power storage devices and configured to absorb expansion of the power storage devices, and a plurality of heat-transfer plates arranged in such a way as to respectively make contact with the plurality of power storage devices,
wherein a plurality of heat-conduction members configured to respectively conduct heat from the plurality of heat-transfer plates to the housing, and a plurality of sliding members respectively joined to first ends of the plurality of heat-conduction members and relatively slidable in the one direction, are arranged between the plurality of heat-transfer plates and the housing.

2. The power storage device pack according to claim 1,
wherein each sliding member is arranged between one of the heat-conduction members and the housing and is slidable in the one direction relative to the housing.

3. The power storage device pack according to claim 2,
wherein each heat-transfer plate includes a main body part making contact with a main surface of one of the power storage devices, and a heat-transfer part bent in the one direction at one end of the main body part, and
an other end of each heat-conduction member is joined to the heat-transfer part,
the other end of each heat-conduction member being joined to the heat-transfer part in such a way as to be offset toward the main body part.

4. The power storage device pack according to claim 1,
wherein each sliding member is arranged between one of the heat-transfer plates and one of the heat-conduction members and is slidable in the one direction relative to the heat-transfer plates.

5. The power storage device pack according to claim 4,
wherein each heat-transfer plate includes a main body part making contact with a main surface of one of the power storage devices, and a heat-transfer part bent toward the elastic member in the one direction at one end of the main body part,
each sliding member is in contact with the heat-transfer part, and
another end of each heat-conduction member is joined to the housing.

6. A power storage device pack comprising:
a housing; and
a power storage device module fixed to the housing,
the power storage device module including a plurality of power storage devices arranged in one direction, a pair of binding members configured to bind the plurality of power storage devices at both ends in the one direction, an elastic member arranged between one of the binding members and one of the power storage devices and configured to absorb expansion of the power storage devices, and a plurality of heat-transfer surfaces configured to thermally connect the plurality of power storage devices and the housing, respectively,
wherein a plurality of heat-conduction members configured to respectively conduct heat from the plurality of heat-transfer surfaces to the housing, and a plurality of sliding members respectively joined to first ends of the plurality of heat-conduction members and relatively slidable in the one direction, are arranged between the plurality of heat-transfer surfaces and the housing.

7. The power storage device pack according to claim 6,
wherein each sliding member is arranged between one of the heat-conduction members and the housing and is slidable in the one direction relative to the housing.

8. The power storage device pack according to claim 6,
wherein each sliding member is arranged between one of the heat-transfer surfaces and one of the heat-conduction members and is slidable in the one direction relative to the heat-transfer surfaces.

9. The power storage device pack according to claim 6,
wherein the power storage device module further includes a plurality of heat-transfer plates arranged in such a way as to respectively make contact with the plurality of power storage devices,
each heat-transfer plate including a main body part making contact with a main surface of one of the power storage devices, and a heat-transfer part bent in the one direction at one end of the main body part,
the heat-transfer part including one of the heat-transfer surfaces.

10. The power storage device pack according to claim 1,
wherein a width of each sliding member is greater than or equal to a width of one of the heat-conduction members.

11. The power storage device pack according to claim 6,
wherein a width of each sliding member is greater than or equal to a width of one of the heat-conduction members.
